(19) United States
(12) Patent Application Publication
(10) Pub. No.: US 2023/0376912 A1
(43) Pub. Date: Nov. 23, 2023

(54) MOBILE APPLICATION-BASED BICYCLE REPAIR, WARRANTY CLAIM PROCESSING, RECALL NOTIFICATION, AND TRIP ANALYSIS

(71) Applicant: Menahem Holdings LLC, Fountain Valley, CA (US)

(72) Inventor: Ben Menahem, Fountain Valley, CA (US)

(21) Appl. No.: 18/318,332

(22) Filed: May 16, 2023

Related U.S. Application Data
(60) Provisional application No. 63/365,118, filed on May 20, 2022.

(51) Int. Cl. G06Q 10/20; G06Q 30/012; G06Q 30/014

(52) U.S. Cl. CPC G06Q 10/20; G06Q 30/012; G06Q 30/014

(57) ABSTRACT

Methods of supporting mobile application-based bicycle repair, warranty claim processing, and trip analysis include storing a bicycle serial number in association with a user identifier identifying a user of a mobile application and receiving bicycle trip data from a mobile communication device having the mobile application installed thereon, the bicycle trip data derived by the mobile application based at least in part on sensor data collected from one or more sensors disposed on a bicycle. The bicycle trip data may be associated with the bicycle serial number based on the association between the bicycle serial number and the user identifier identifying the user of the mobile application. The bicycle trip data may, for example, be provided to a bicycle repair service provider capable of deriving bicycle repair service information therefrom, which may be provided to the mobile communication device and displayable by the mobile application.

### CROSS-REFERENCE TO RELATED APPLICATIONS

This application relates to and claims the benefit of U.S. Provisional Application No. 63/365,118, filed May 20, 2022 and entitled “MOBILE APPLICATION-BASED BICYCLE REPAIR, WARRANTY CLAIM PROCESSING, RECALL NOTIFICATION, AND TRIP ANALYSIS,” the entire contents of which is expressly incorporated by reference.

### STATEMENT RE: FEDERALLY SPONSORED RESEARCH/DEVELOPMENT

Not Applicable

### BACKGROUND

For amateur and competitive riders alike, tracking the usage of one's bicycle can be a great benefit to achieving training and fitness goals. While there are various mobile applications (“apps”) on the market that aim to assist riders with logging ride data, existing offerings do not view bicycle ownership from all relevant perspectives and thus fail to recognize the needs of all interested parties. Responsible bicycle ownership requires vigilant monitoring of bicycle performance to ensure that the bicycle is being properly maintained and is safe to ride, an aspect that affects not only the rider but also the manufacturer of the bicycle and the various retailers and service shops that encounter the bicycle during its life. From the perspective of bicycle manufacturers, for example, a safety recall may be necessary due to a defect in a particular bicycle, but existing systems fail to adequately connect the manufacturer with the owner of the bicycle to inform the owner of the recall. From the perspective of retailers and service shops, the effectiveness of services, and thus customer satisfaction and rider safety, may be limited by a lack of up-to-date information on the bicycles that are sold and serviced by these stores, beginning from the moment the bicycle leaves the store.

### BRIEF SUMMARY

The present disclosure contemplates various systems and methods for overcoming the above drawbacks accompanying the related art. One aspect of the embodiments of the present disclosure is a method of supporting mobile application-based bicycle repair. The method may comprise storing a bicycle serial number in association with a user identifier identifying a user of a mobile application and receiving bicycle trip data from a mobile communication device having the mobile application installed thereon, the bicycle trip data derived by the mobile application based at least in part on sensor data collected from one or more sensors disposed on a bicycle. The method may further comprise associating the bicycle trip data with the bicycle serial number based on the association between the bicycle serial number and the user identifier identifying the user of the mobile application. The method may further comprise providing the bicycle trip data to a bicycle repair service provider capable of deriving bicycle repair service information from the bicycle trip data, receiving the bicycle repair service information from the bicycle repair service provider, and providing the bicycle repair service information to the mobile communication device. The bicycle repair service information may be displayable on the mobile communication device by the mobile application.

The bicycle trip data may include one or more items of data selected from the group consisting of speed, duration, distance, cadence, estimated calories burned, incline, decline, battery level, and tire pressure. The bicycle trip data may be derived based on heart rate data collected from a device worn by the user. The bicycle trip data may be derived based on oxygen level data collected from a device worn by the user.

The method may comprise storing, in association with the user identifier, a record of bicycle repair service performed on the bicycle. The method may comprise storing a plurality of records of the bicycle trip data in association with the user identifier. An aggregation of the plurality of records may be displayable on the mobile communication device by the mobile application. The method may comprise receiving, from a retail store, a warranty claim including the bicycle serial number, associating the warranty claim with the user identifier based on the association between the bicycle serial number and the user identifier identifying the user of the mobile application, and providing the plurality of trip records and the warranty claim to a manufacturer of the bicycle.

The method may comprise receiving, from a manufacturer of the bicycle, recall information including one or more bicycle model numbers corresponding to the bicycle serial number, associating the recall information with the user identifier based on the association between the bicycle serial number and the user identifier identifying the user of the mobile application, and providing the recall information to the mobile communication device. The recall information may be displayable on the mobile communication device by the mobile application.

The method may comprise receiving a theft notification (indicating that the bicycle has been stolen) from the mobile communication device in response to a user input to the mobile application, associating the theft notification with the bicycle serial number based on the association between the bicycle serial number and the user identifier identifying the user of the mobile application, receiving, from the bicycle repair service provider, a request including the bicycle serial number, and, in response to the request, providing the theft notification associated with the bicycle serial number to the bicycle repair service provider.

The method may comprise receiving a request for bicycle repair service from the mobile communication device in response to a user input to the mobile application, receiving, from the mobile communication device, a geolocation of the mobile communication device, and, in response to the request for bicycle repair service, providing, to the mobile communication device, one or more geolocations of bicycle repair service providers based on a relationship between the one or more geolocations and the geolocation of the mobile communication device.

Another aspect of the embodiments of the present disclosure is a method of supporting mobile application-based bicycle warranty claim processing. The method may comprise storing a bicycle serial number in association with a user identifier identifying a user of a mobile application and receiving bicycle trip data from a mobile communication device having the mobile application installed thereon, the bicycle trip data derived by the mobile application based at least in part on sensor data collected from one or more sensors disposed on a bicycle. The method may further comprise associating the bicycle trip data with the bicycle serial number based on the association between the bicycle serial number and the user identifier identifying the user of the mobile application. The method may further comprise receiving, from a retail store, a warranty claim including the bicycle serial number, associating the warranty claim with the user identifier based on the association between the bicycle serial number and the user identifier identifying the user of the mobile application, and providing the bicycle trip data and the warranty claim to a manufacturer of the bicycle.

Another aspect of the embodiments of the present disclosure is a method of supporting mobile application-based bicycle trip analysis. The method may comprise storing a bicycle serial number in association with a user identifier identifying a user of a mobile application and receiving bicycle trip data from a mobile communication device having the mobile application installed thereon, the bicycle trip data derived by the mobile application based at least in part on sensor data collected from one or more sensors disposed on a bicycle. The method may further comprise associating the bicycle trip data with the bicycle serial number based on the association between the bicycle serial number and the user identifier identifying the user of the mobile application. The method may further comprise storing a plurality of records of the bicycle trip data in association with the user identifier, receiving a request for trip analysis from the mobile communication device in response to a user input to the mobile application, and providing an aggregation of the plurality of records to the mobile communication device. The aggregation of the plurality of records may be displayable on the mobile communication device by the mobile application.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for supporting mobile application-based bicycle repair, warranty claim processing, recall notification, and trip analysis according to an embodiment of the present disclosure;

FIG. 2 shows a screen of a mobile application of the system, the screen displaying fields for inputting personal information during a signup process;

FIG. 3 shows a screen of the mobile application displaying fields for inputting health-related information;

FIG. 4 shows a screen of the mobile application displaying fields for inputting bicycle information;

FIG. 5 shows a screen of the mobile application displaying trip data associated with a bicycle trip;

FIG. 6 shows a screen of the mobile application displaying distance details associated with the bicycle trip;

FIG. 7 shows a screen of the mobile application displaying average speed details associated with the bicycle trip;

FIG. 8 shows a screen of the mobile application displaying duration details associated with the bicycle trip;

FIG. 9 shows a screen of the mobile application displaying cadence details associated with the bicycle trip;

FIG. 10 shows a screen of the mobile application displaying details of calories burned in association with the bicycle trip;

FIG. 11 shows a screen of the mobile application displaying heart rate details associated with the bicycle trip;

FIG. 12 shows a screen of the mobile application displaying incline details associated with the bicycle trip;

FIG. 13 shows a screen of the mobile application displaying decline details associated with the bicycle trip;

FIG. 14 shows a screen of the mobile application displaying battery level details associated with the bicycle trip;

FIG. 15 shows a screen of the mobile application displaying oxygen level details associated with the bicycle trip;

FIG. 16 shows a screen of the mobile application displaying an aggregation of trip data;

FIG. 17 shows a screen of the mobile application displaying distance details associated with the aggregation of trip data;

FIG. 18 shows a screen of the mobile application displaying average speed details associated with the aggregation of trip data;

FIG. 19 shows a screen of the mobile application displaying duration details associated with the aggregation of trip data;

FIG. 20 shows a screen of the mobile application displaying cadence details associated with the aggregation of trip data;

FIG. 21 shows a screen of the mobile application displaying heart rate details associated with the aggregation of trip data;

FIG. 22 shows a screen of the mobile application displaying incline details associated with the aggregation of trip data;

FIG. 23 shows a screen of the mobile application displaying decline details associated with the aggregation of trip data;

FIG. 24 shows a screen of the mobile application displaying oxygen level details associated with the aggregation of trip data;

FIG. 25 shows a screen of the mobile application displaying goals of the user;

FIG. 26 shows a screen of the mobile application for adding a goal;

FIG. 27 shows a screen of the mobile application displaying data of other users of the mobile application;

FIG. 28 shows a screen of the mobile application displaying upcoming and completed repairs of the bicycle;

FIG. 29 shows a screen of the mobile application displaying repairs in progress of the bicycle;

FIG. 30 shows a screen of the mobile application displaying upcoming repairs of the bicycle;

FIG. 31 shows a screen of the mobile application displaying completed repairs of the bicycle;

FIG. 32 shows a screen of the mobile application showing appointment details of a newly created service appointment;

FIG. 33 shows a screen of the mobile application showing appointment details of a service appointment in progress;

FIG. 34 shows a screen of the mobile application showing appointment details of a completed service appointment;

FIG. 35 shows another screen of the mobile application showing appointment details of the completed service appointment;

FIG. 36 shows a screen of the mobile application showing notifications in relation to service appointments;

FIG. 37 shows a screen of the mobile application for selecting a store;

FIG. 38 shows a screen of the mobile application displaying a user interface for booking an appointment with the store;

FIG. 39 shows a screen of the mobile application displaying store reviews;

FIG. 40 shows a screen of the mobile application for editing a user profile;

FIG. 41 shows another screen of the mobile application for editing a user profile;

FIG. 42 shows a screen of the mobile application for indicating that the user's bicycle has been stolen; and

FIG. 43 shows a screen of the mobile application for selecting between payment methods.

### DETAILED DESCRIPTION

The present disclosure encompasses various embodiments of mobile application-based bicycle repair, warranty claim processing, recall notification, and trip analysis systems and methods. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

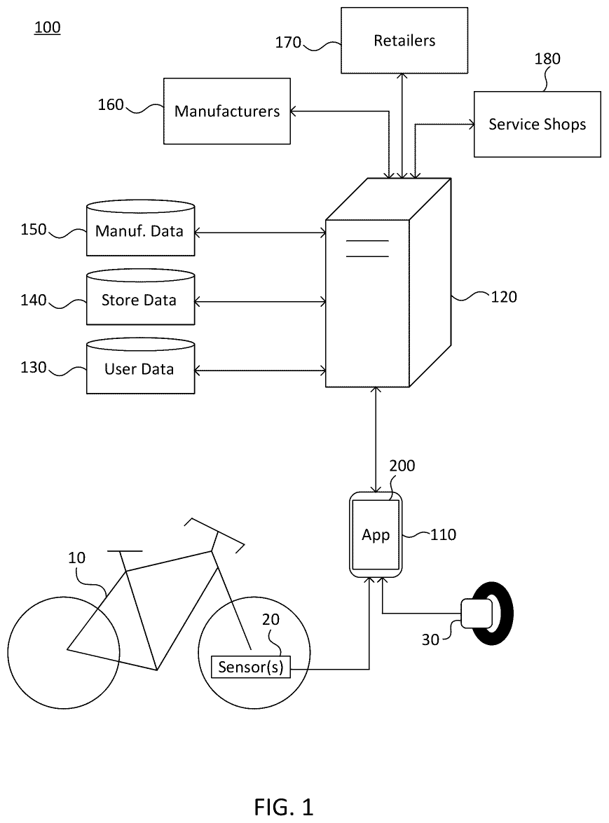

FIG. 1 shows a system 100 for supporting the mobile application-based functionality described herein. A rider of a bicycle 10 may install a mobile application (“app”) 200 on his or her smartphone or other mobile communication device 110. A server 120 in communication with the mobile communication device 110 (via the app 200) may provide the rider and other interested parties with a variety of information including health, service, purchase, and theft data. The app 200 may serve as the rider's interface to a subscription-based software as a service (SAAS) built on an omnichannel communications system for the entire biking community.

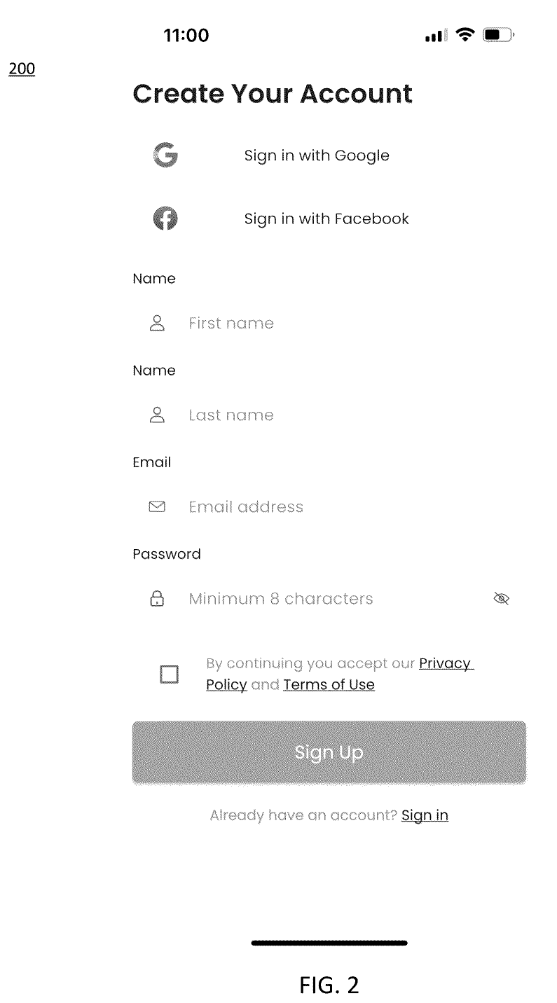

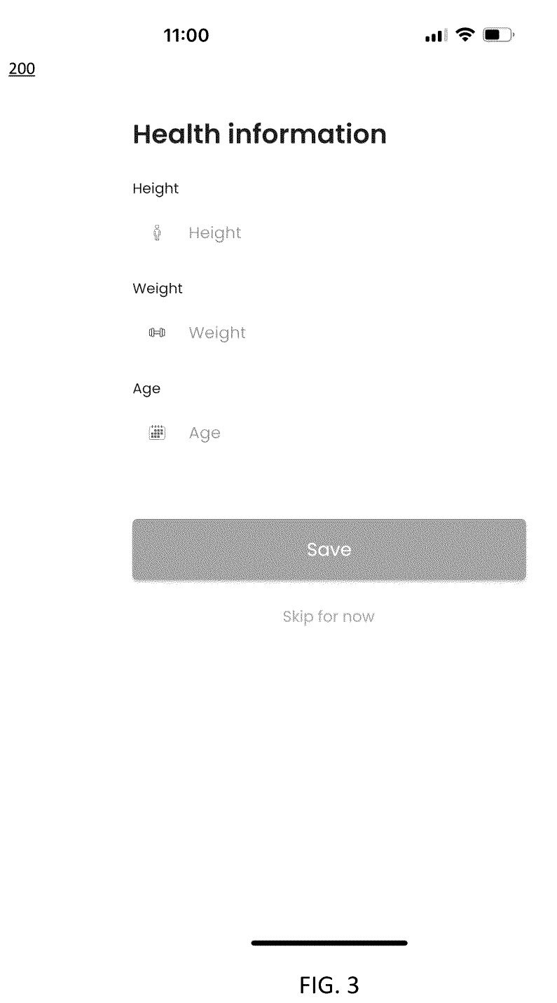

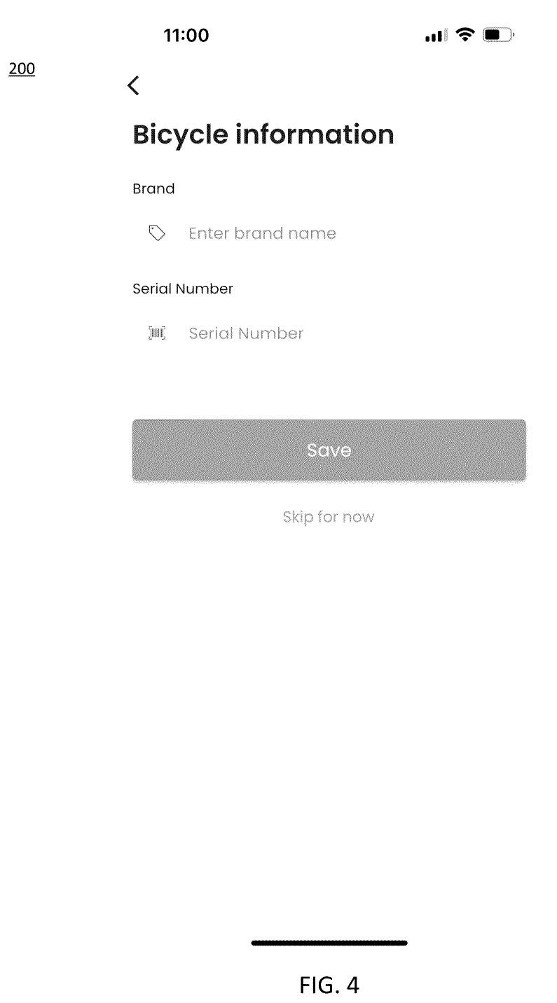

Initial setup of the app 200 may include providing various information to the server 120 using the mobile communication device 110 (e.g., by entering information into a user interface of the app 200), which may be stored in association with a user identifier (e.g., an alphanumeric user ID) that identifies the user of the app 200. The collected information may include, for example, personal and contact information of the user (e.g., name, email address, phone number, etc.), including fitness and health-related information such as height, weight, and age, along with user login information (e.g., username, password, etc.) in order to generate login credentials for the user (see example screens shown in FIGS. 2 and 3). The server 120 may store the information in association with the user identifier in a user data storage 130 as shown in FIG. 1, for example. Of particular relevance to various embodiments described herein, the information stored in association with the user identifier may include a bicycle serial number of the bicycle 10, which may be entered by the user (see example screen of FIG. 4) or in some cases provided by a retailer 170 at the time of purchase (e.g., based on a match between personal information of the buyer and personal information entered into the app 200). By storing the bicycle serial number in association with the user identifier, the server 120 may be able to identify which app user is associated with any future events involving that particular bicycle 10, resulting in beneficial functionality for various interested parties as described herein.

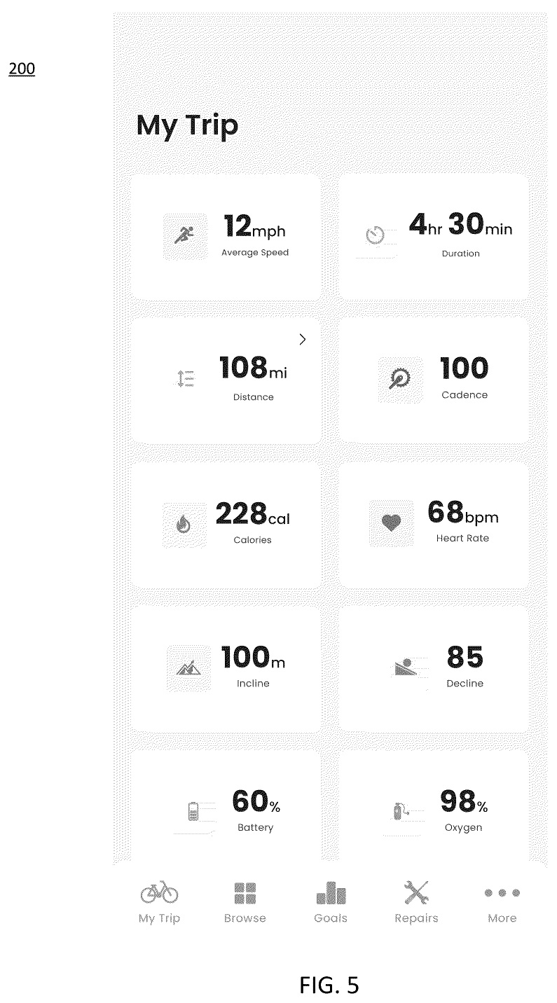

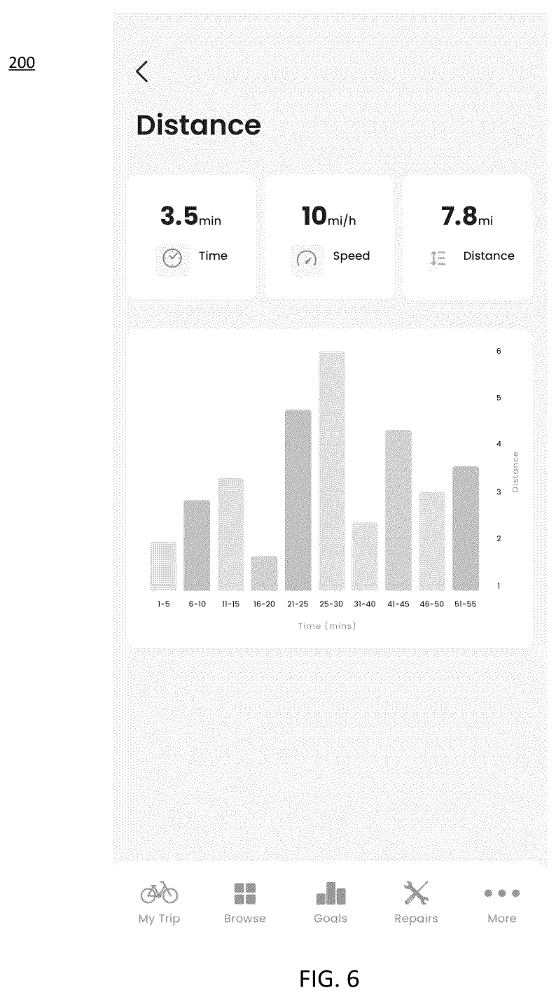

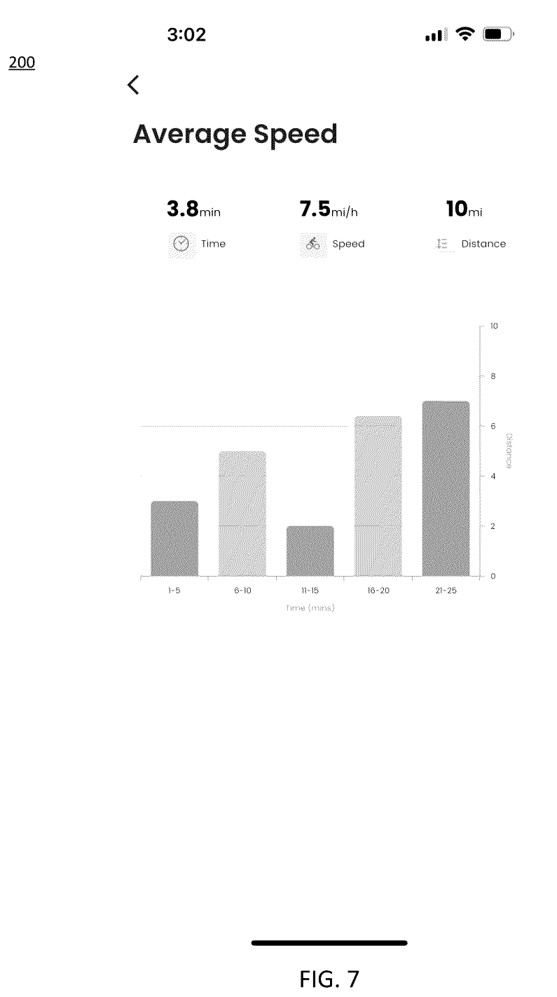

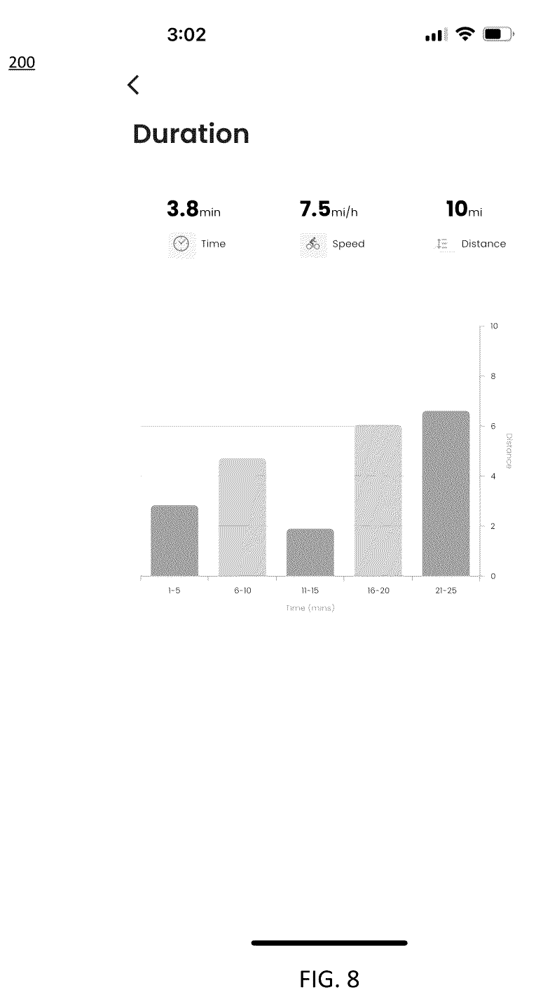

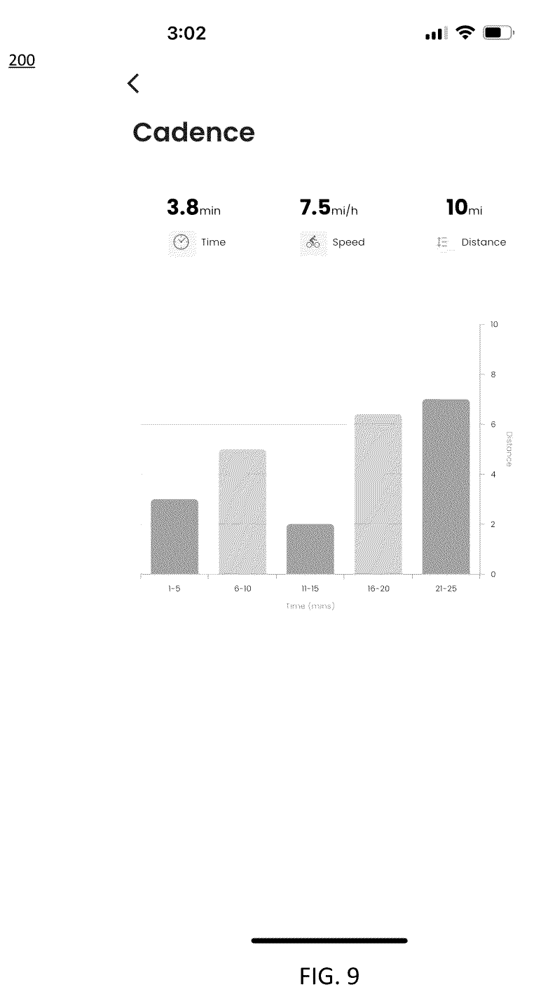

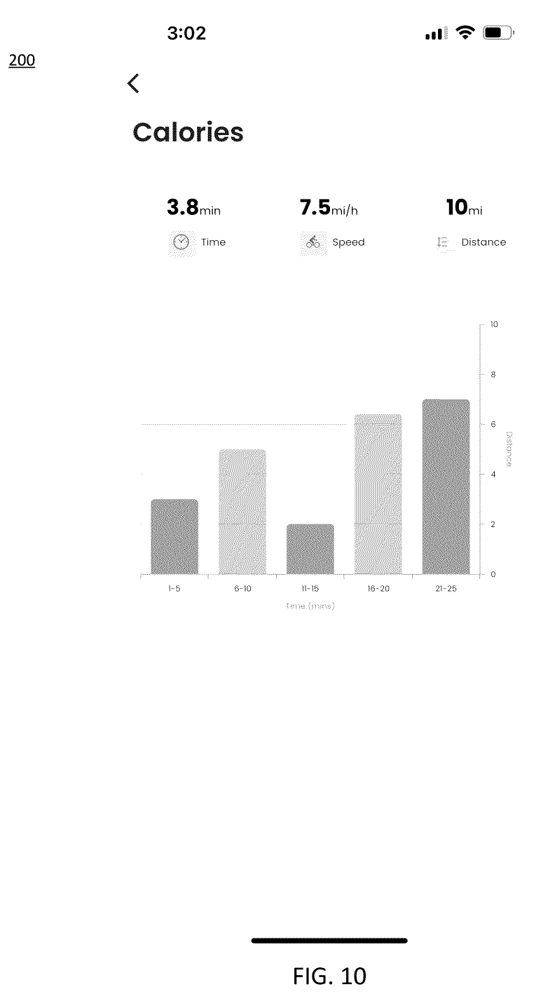

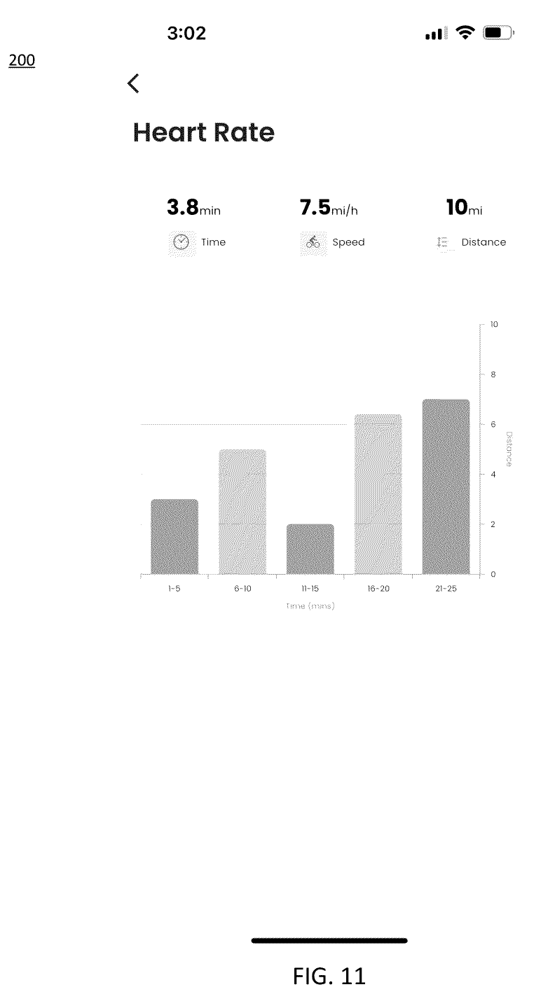

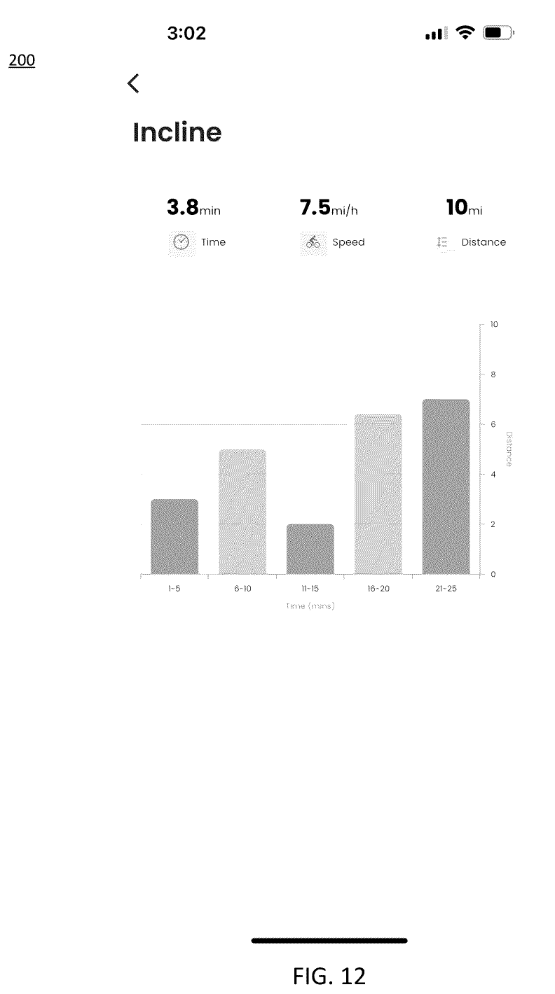

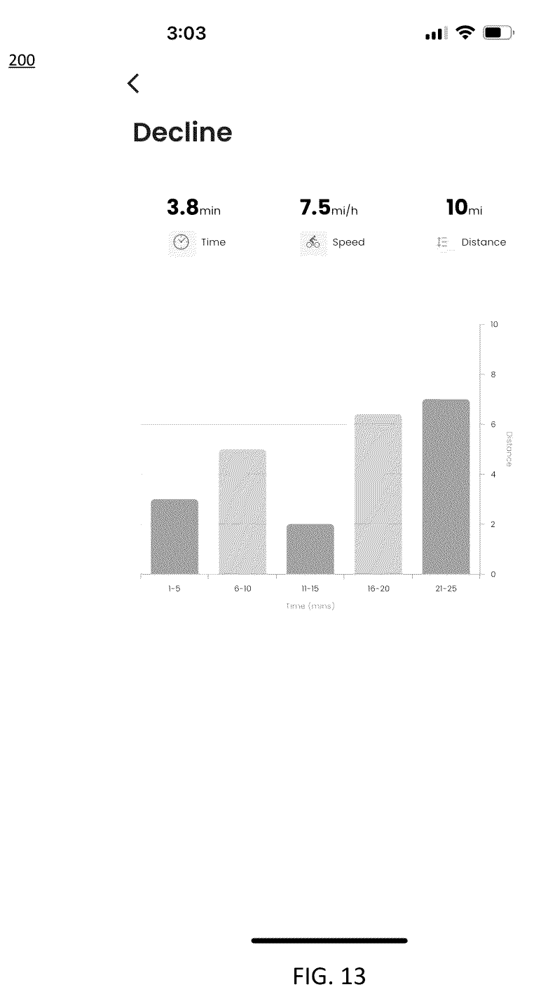

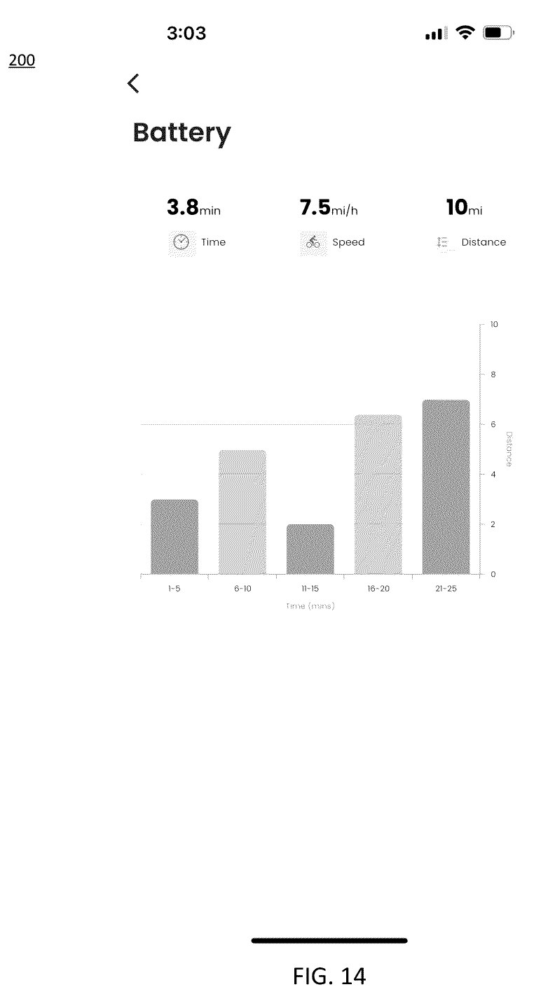

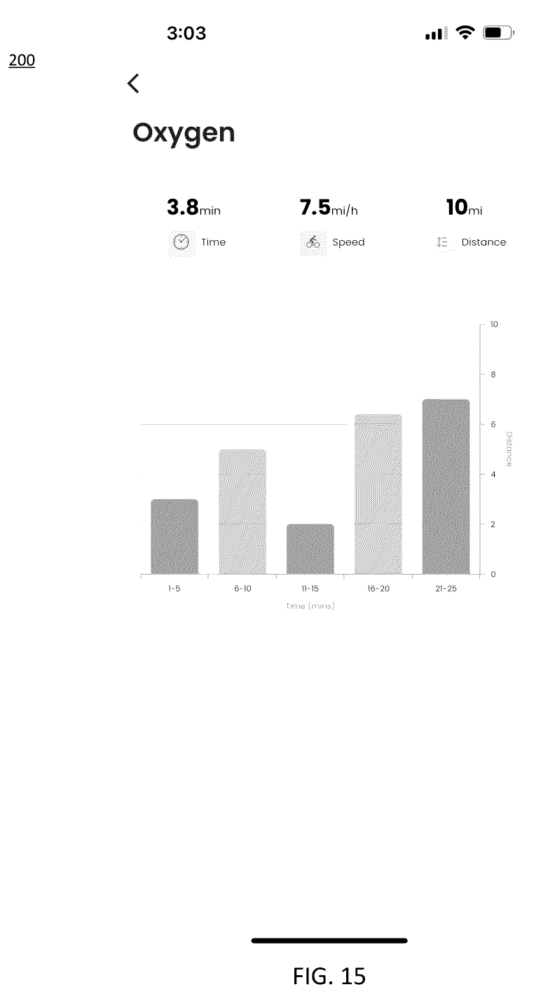

In one aspect of the embodiments described herein, the app 200 may report riding statistics to the user. To this end, the app 200 may communicate (e.g., by Bluetooth or other short-range wireless communication protocol) with one or more sensors 20 disposed on the bicycle 10 (e.g., preinstalled or retrofitted) to measure any number of statistics, for example (but not limited to) speed, duration, distance, cadence, estimated calories burned, incline, decline, battery levels (if electric powered bicycle), tire pressure (e.g., TPMS), etc. The app 200 may simultaneously be paired with a device worn by the user such as a smartwatch or other wearable technology in order to additionally track health statistics such as heart rate, oxygen level, blood pressure, etc., which may be correlated by the app 200 with the data obtained from the sensor(s) 20 (e.g., by timestamping) for later evaluation. An example of such collected data is shown in FIG. 5, which is an example of a screen of the app 200 that displays trip data associated with a bicycle trip. The screen of FIG. 5 may be accessible using a “My Trip” navigation button as shown at the bottom of the screen, for example. In some cases, it may be possible to drill down into one or more items of data for more detailed information. For example, tapping on “Distance” may navigate the app 200 to the screen shown in FIG. 6, where the distance traveled may be further broken down into distances traveled during each leg of the trip as shown by the example bar graph. Additional examples of drilldown screens that may be reached from the screen of FIG. 5 are shown in FIGS. 6-15.

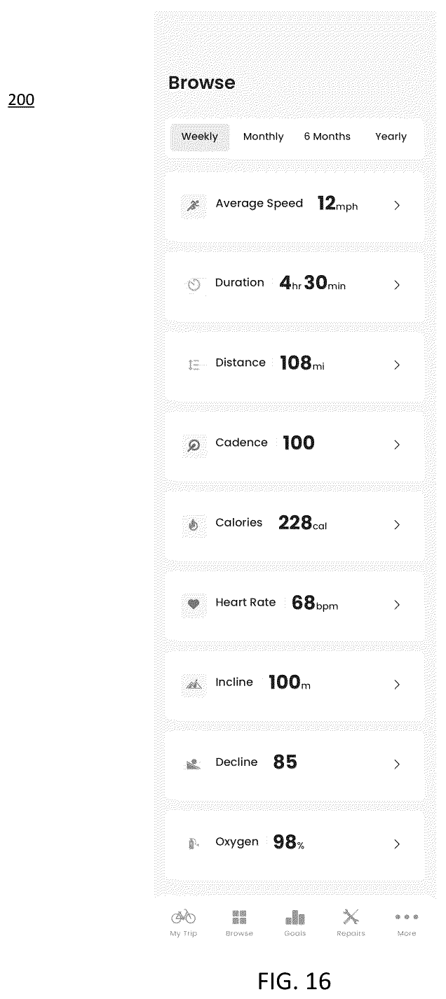

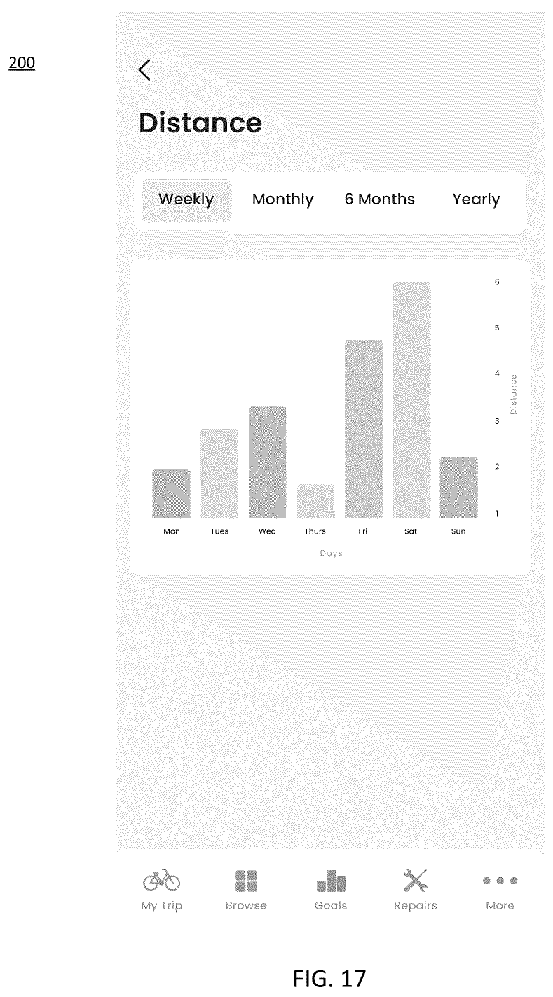

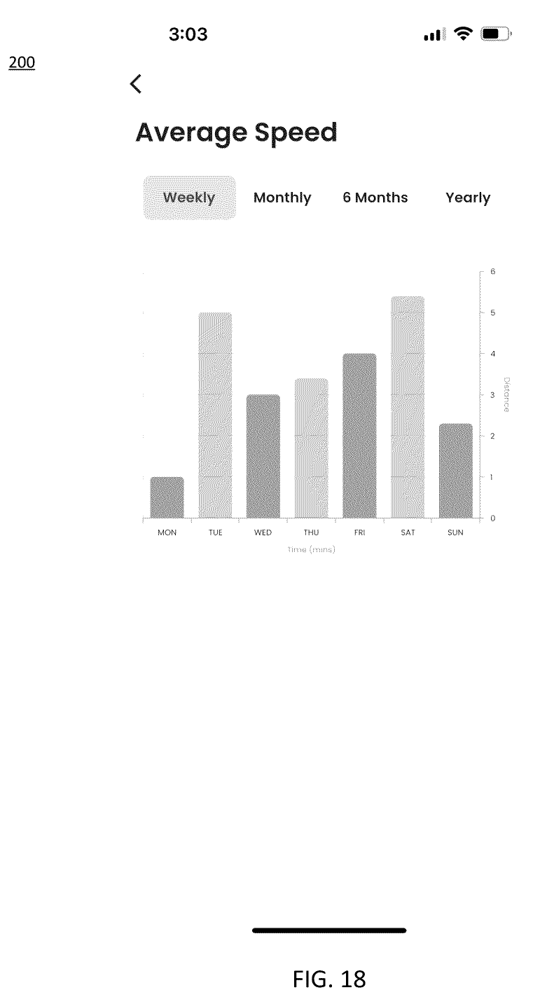

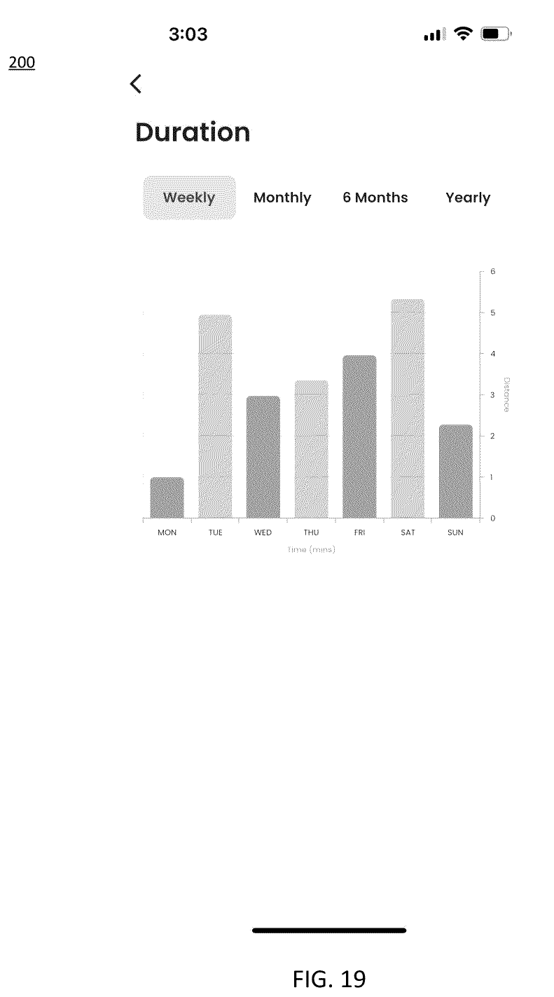

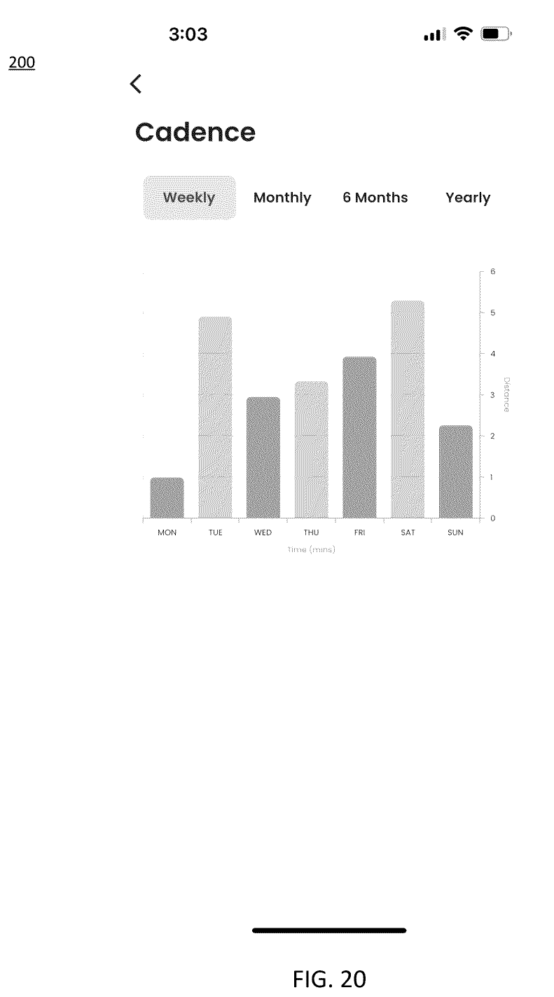

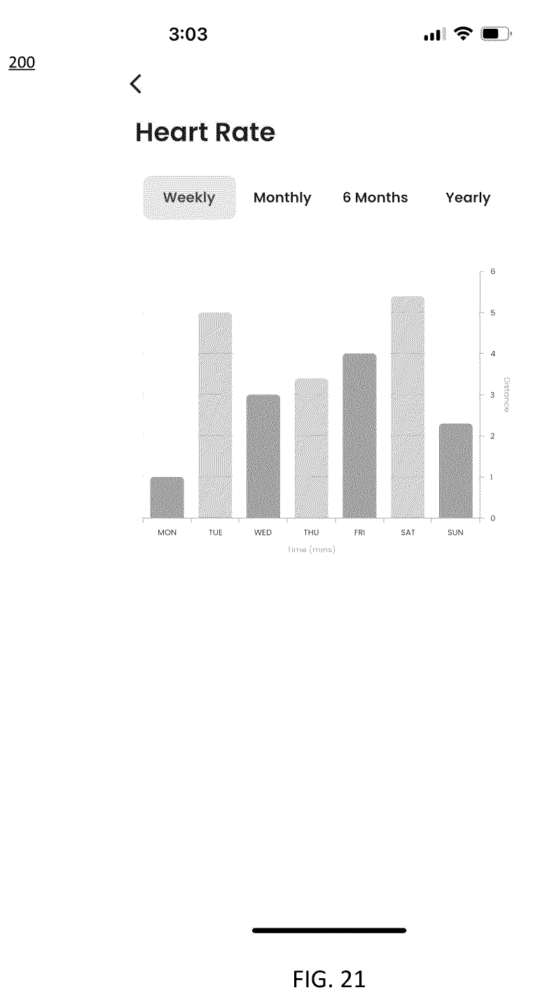

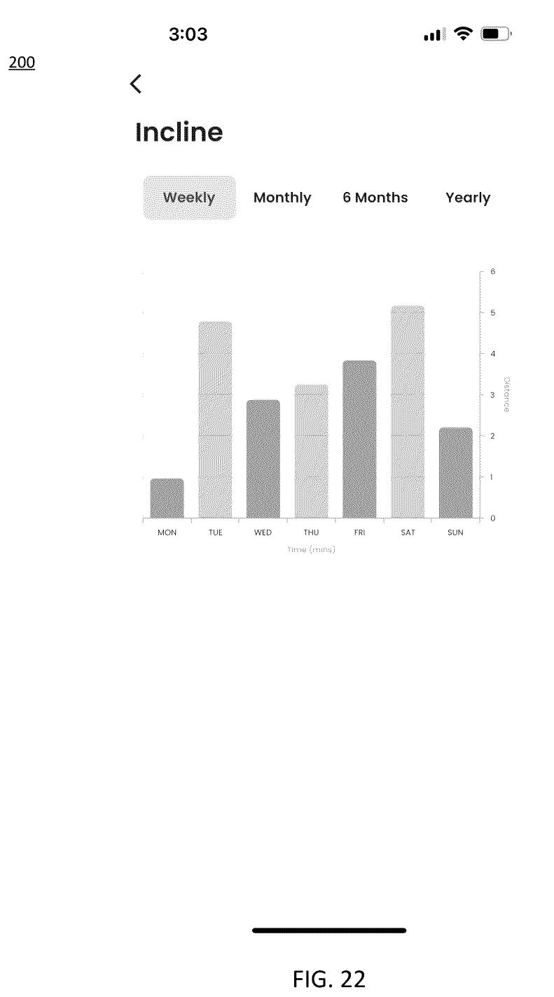

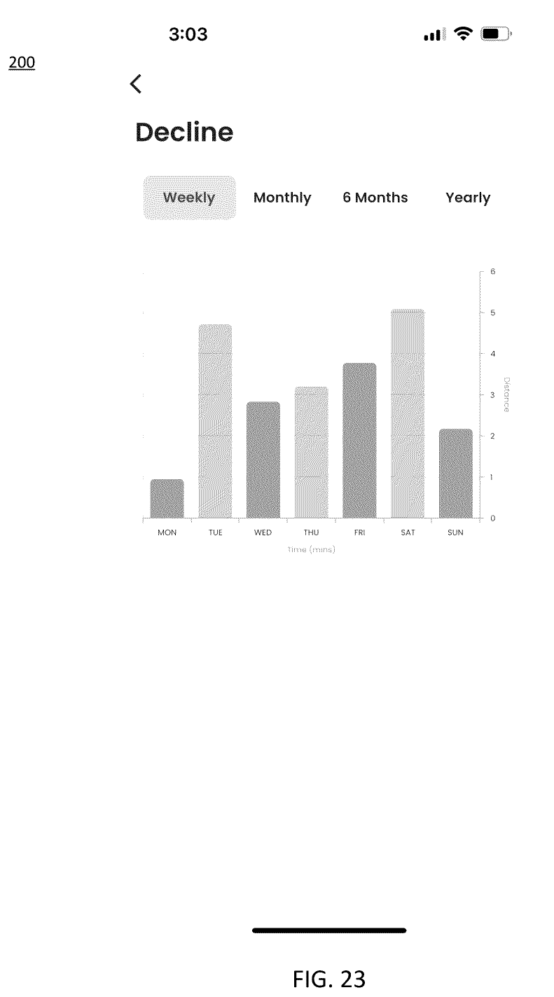

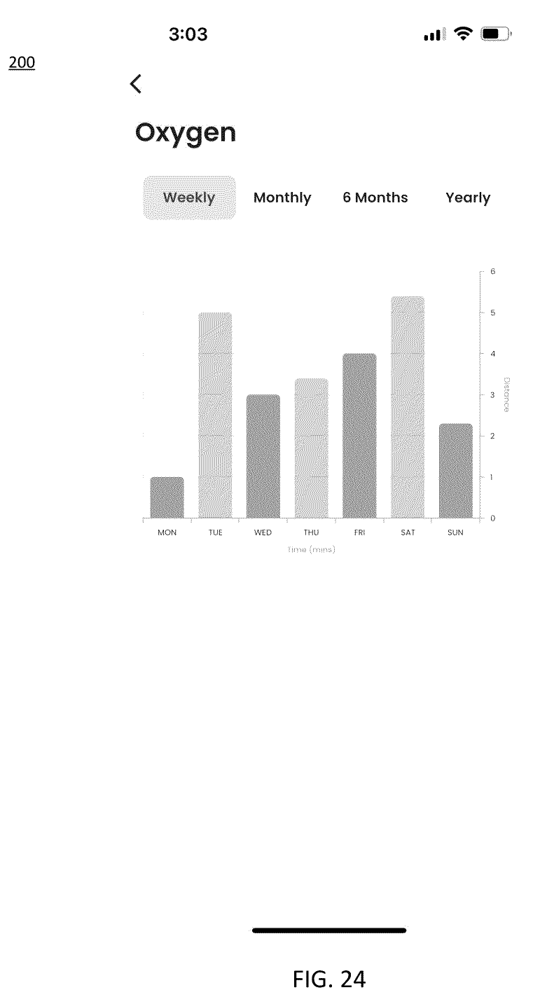

Through communication with the mobile communication device 110, the server 120 may receive such bicycle trip data that may be derived by the app 200 based on sensor data collected from the sensor(s) 20 and/or health data collected from the wearable device 30. The server 120 may associate the bicycle trip data with the user identifier (and with the bicycle serial number) in the user data storage 130. In this way, over time, the server 120 may store a plurality of records of bicycle trip data in association with the user identifier, building up a history of the usage and performance of the bicycle 10. The app 200 may then display an aggregation of the plurality of records on the mobile communication device 110 for the user's review as shown in FIGS. 16-24, for example. In FIG. 16, the user has tapped the “Browse” navigation button and is able to browse weekly, monthly, 6 month, and yearly aggregations of data, which may be in the form of averages, totals, etc. FIG. 17 shows an example drilldown screen of a total weekly distance (as displayed in FIG. 16), with FIG. 17 illustrating the accumulation of the total weekly distance day-by-day over the course of the week as a bar graph. FIGS. 18-24 show additional examples of drilldown screens that may be reached from the screen of FIG. 16.

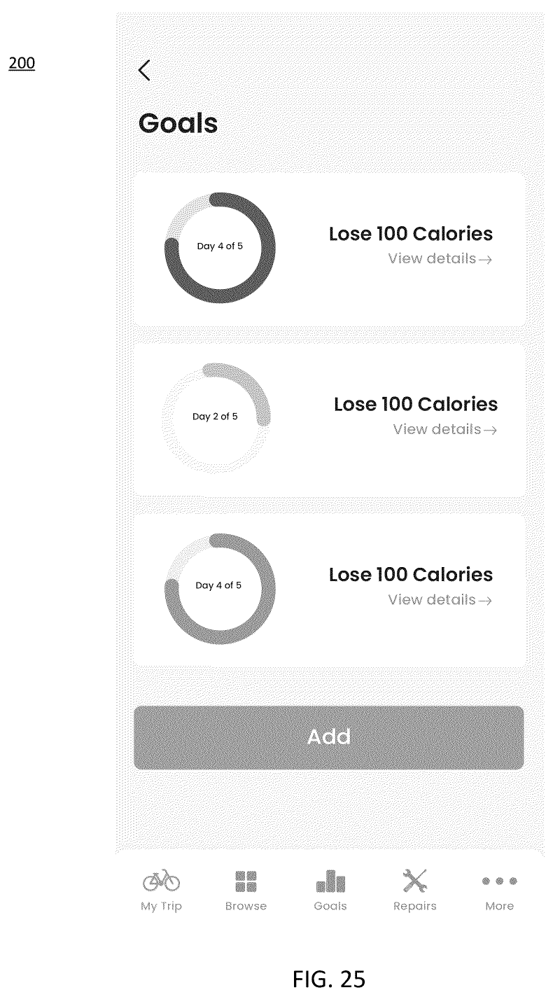

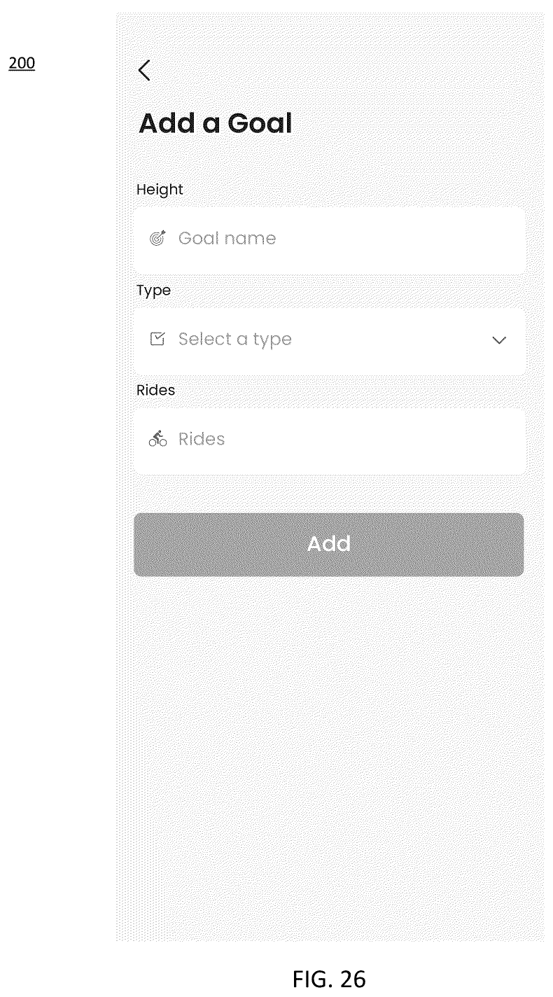

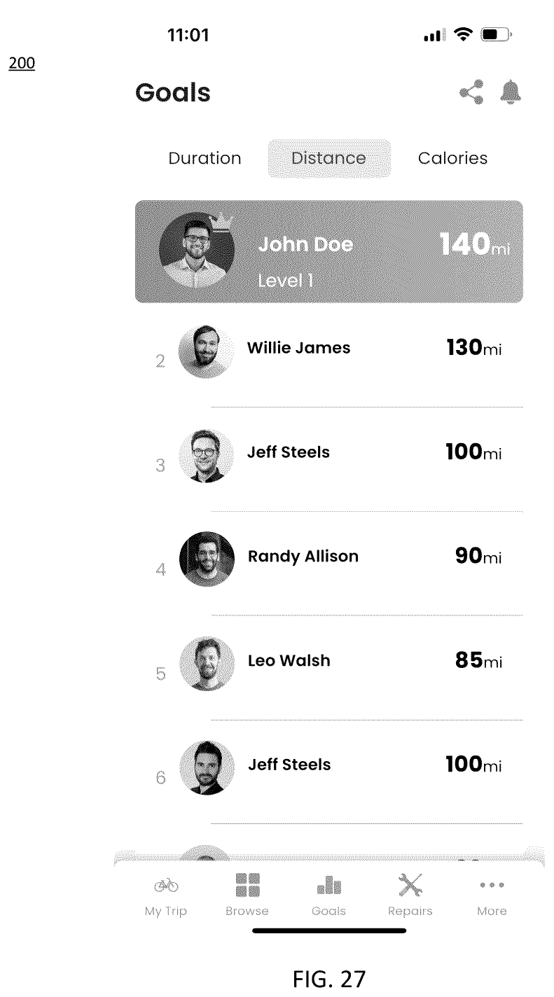

It is also contemplated that users may be able to set riding goals based on any of the monitored statistics they would like to choose from. An example of a screen showing current goal progress is shown in FIG. 25, which may be accessed by tapping the “Goals” navigation button, for example. As shown, for each goal (e.g., “Lose 100 Calories”), the app 200 may display a representation of the progress toward the goal. A new goal may be added by tapping the “Add” button, which may navigate the app 200 to the screen shown in FIG. 26, for example, where the new goal can be named and defined by the user. As shown in FIG. 27, the app 200 may include functionality to allow users to view statistics of other users, for example, in order that users might compete with their friends and/or keep up with their favorite celebrity or bike enthusiast.

In addition to being accessible to the user, who may wish to monitor his/her personal progress within the app 200, the recorded riding data (or a portion thereof) may also be accessible to manufacturers 160, retailers 170, and/or bicycle repair service providers 180 (see FIG. 1) that communicate with the server 120. It is contemplated that any such data sharing may adhere to HIPAA and other data privacy laws and best practices. For example, health data of the user may be kept private and not shared, while other data may be shared after receiving appropriate authorization from the user.

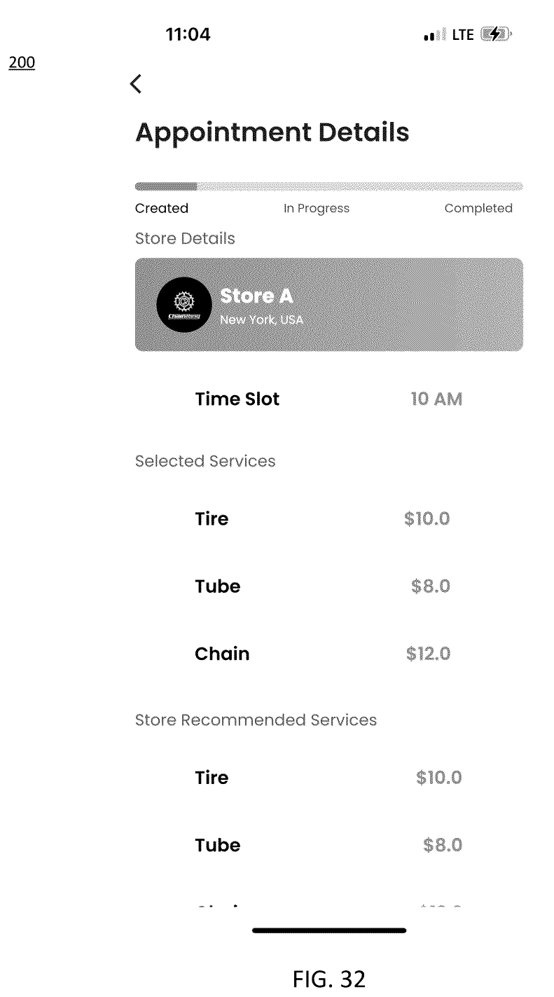

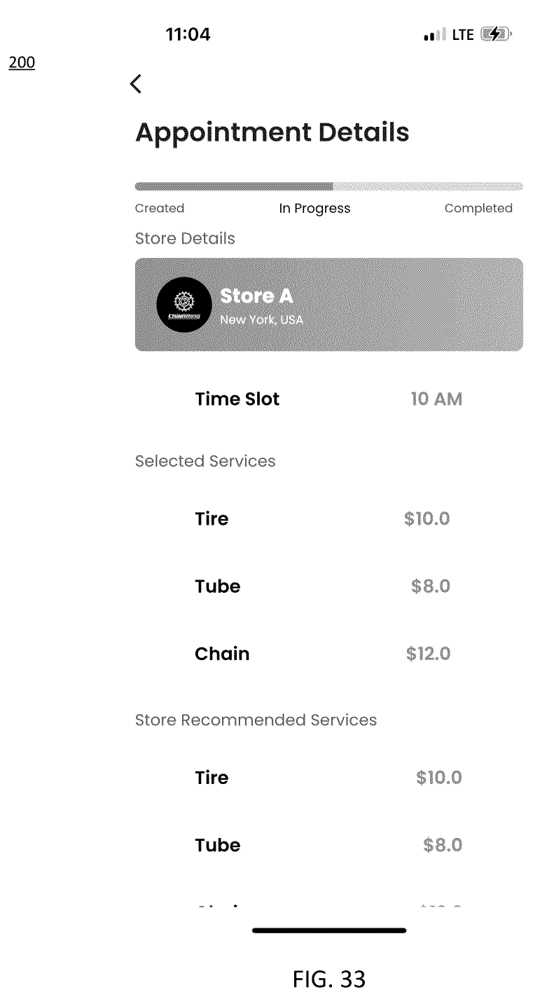

As one example use case, recorded riding data may be used by service shops 180 for diagnostic purposes to ensure that the bicycle 10 is repaired to the extent that is needed. To this end, bicycle trip data may be provided by the server 120 to a service shop 180 (e.g., to a computer operated by the service shop 180) that is capable of deriving bicycle repair service information from the bicycle trip data. The bicycle repair service information may include, for example, a recommended repair (e.g., new tire) and estimated cost. The server 120 may receive the bicycle repair service information from the service shop 180 and provide it to the mobile communication device 110 belonging to the user, where it may be displayed by the app 200 (see FIGS. 32-35, discussed below). In this way, the user of the app 200 may be presented with recommended repairs that are based on data collected from the bicycle 10.

It is contemplated that such recommendations may be provided on demand, such as in a case where the user is experiencing a problem with the bicycle 10 and requests service using the app 200. In response to the user's request, the server 120 may send the user's trip data records to nearby service shop(s) 180, in some cases together with a statement provided by the user to describe the problem that the user is experiencing. The server 120 may then receive the recommendations from the service shop(s) 180 and provide them to the user in the app 200. Alternatively, the recommended repairs may in some cases be generated without any request on the part of the user, based solely on the user's records of trip data and possibly the age and regular maintenance schedule of the bicycle 10. It is contemplated that the server 120 may receive useful service tutorials and manufacturer-recommended maintenance schedules, etc. from manufacturers 160 and store them in a manufacturer data storage 150 in association with a given bicycle model. Tutorials may include, for example, visual tutorials within the retail stores' software to help mechanics with repairs they are unfamiliar with, such as new wiring setup on e-bikes, etc. When a service request and/or trip data is being sent to a service shop 180, the server 120 may check the manufacturer data storage 150 for any available information associated with the model of the bicycle 10 (which may be known from the bicycle serial number, for example). The manufacturer-provided information may then be provided to the service shop 180 to ensure that the mechanic repairs the bicycle 10 correctly and thoroughly. This may be of particular use in the case of new brands entering the market.

The system 100 may allow bicycle repair service providers 180 to further modernize services by evaluating data not just from a single bicycle 10 but from many different bicycles belonging to many different users. For example, the records of trip data collected over time, combined with records of repairs actually performed on such bicycles, may be used to train a machine learning model to recommend likely needed repairs for a given new set of trip data records. In this way, the accumulation of data by the server 120 may improve not only the convenience of riders and other interested parties but the quality of repairs as well.

After the bicycle 10 has been serviced, the server 120 may receive information detailing the bicycle repair service that was performed on the bicycle 10 from the bicycle repair service provider 180 (or from the user via the app 200). The server 120 may then store a record of bicycle repair service in association with the user identifier (e.g., in the user data storage 130). In this way, the system 100 may keep bicycle maintenance and repair data all in one place, with service records able to be shared among different service outlets to ensure each bike's history is well known to all who lay a hand on it. Such history may be used by the app 200 to remind the user of the service needs of the bicycle 10 (e.g., “Your bicycle has not been serviced for over a year”). It is also contemplated that the user may be able to schedule and pay for service appointments through the app 200. All repair invoices may be stored within the user data storage 130 and/or within the store data storage 140 (which may store information associated with retailers 170 and service shops 180, for example) and may be tracked using the bicycle serial number. All related bicycle transactions may be recorded and logged within the database(s) of the system 100 to track ownership, warranty eligibility and previous claims, theft, previous repairs, recalls and more.

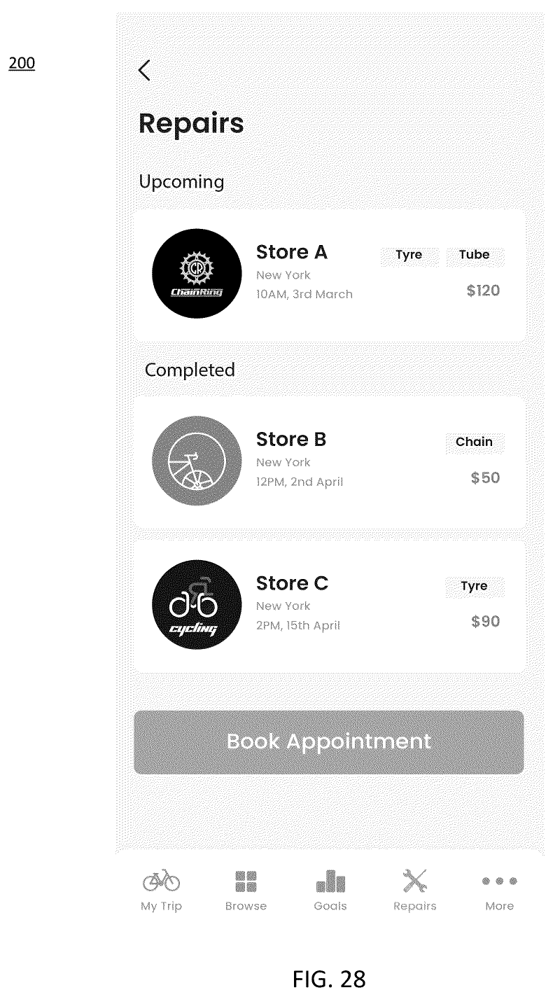

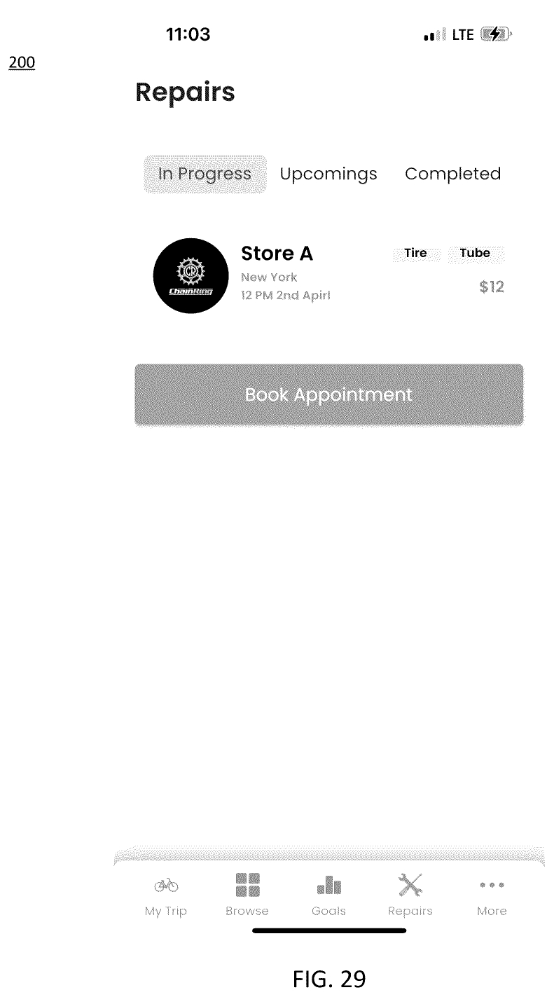

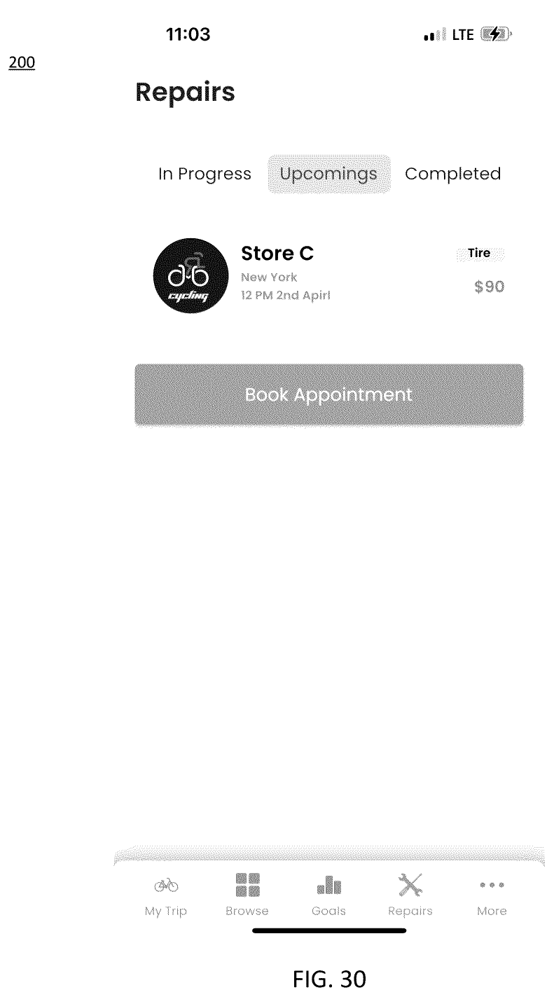

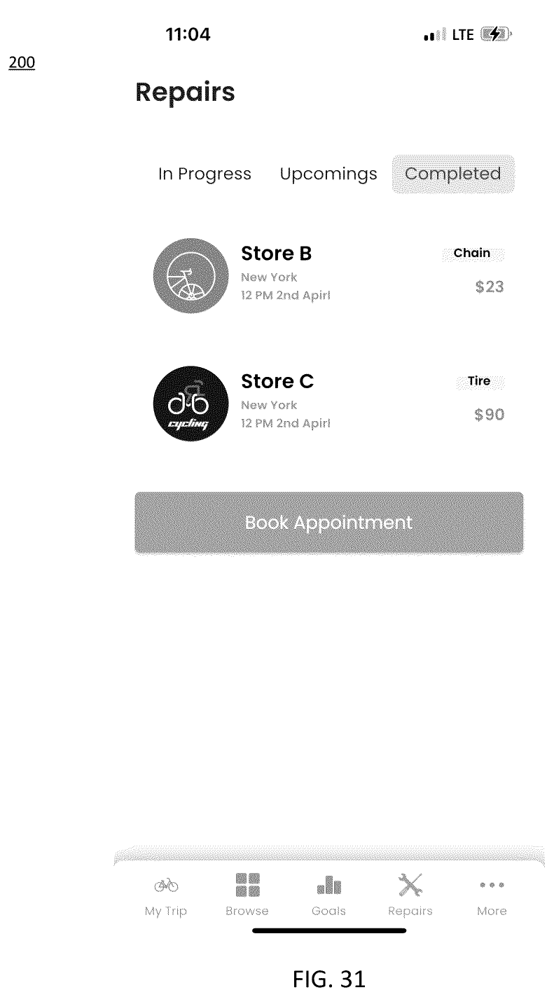

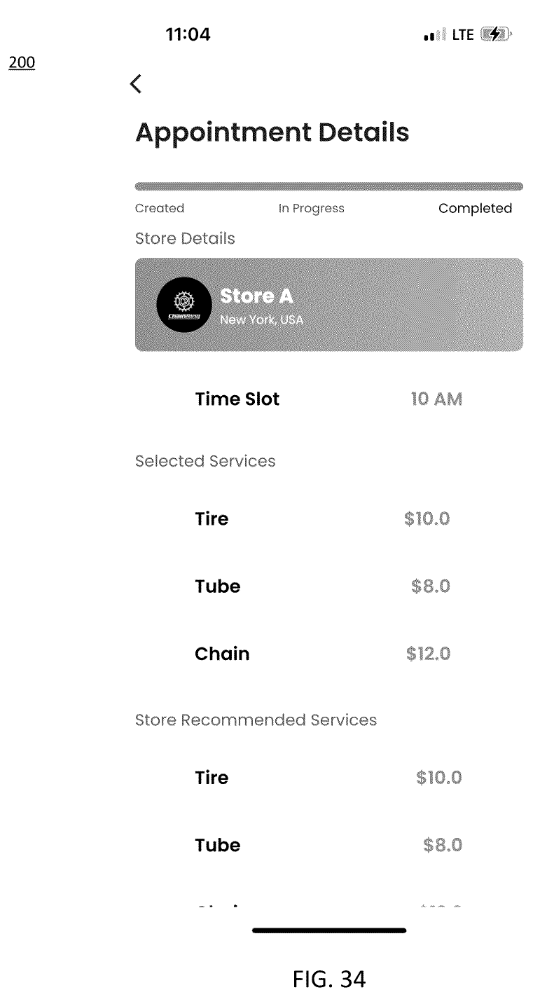

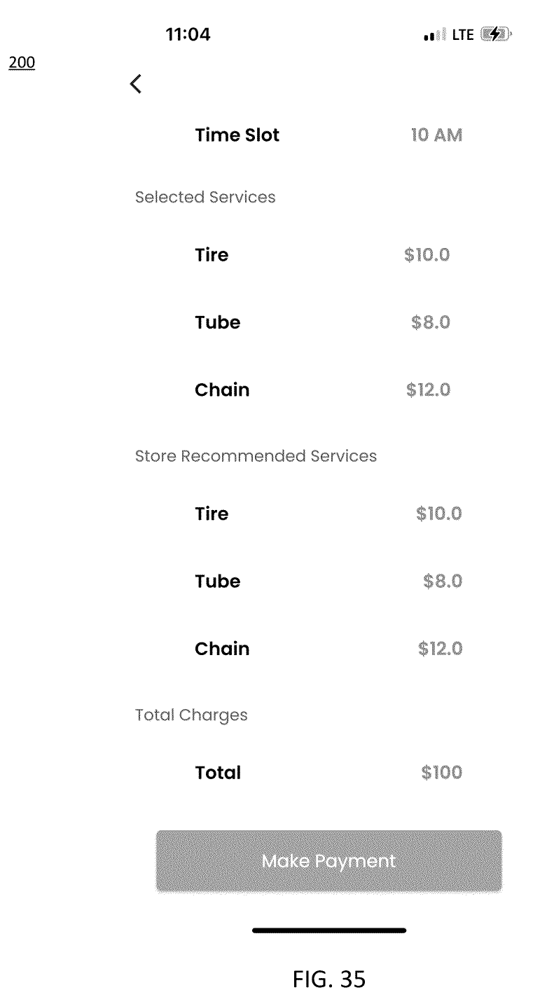

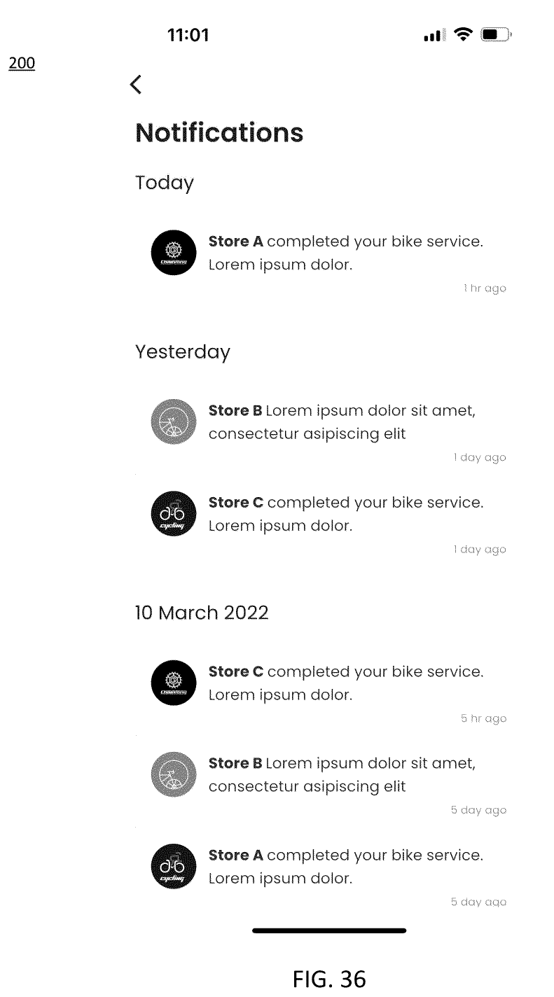

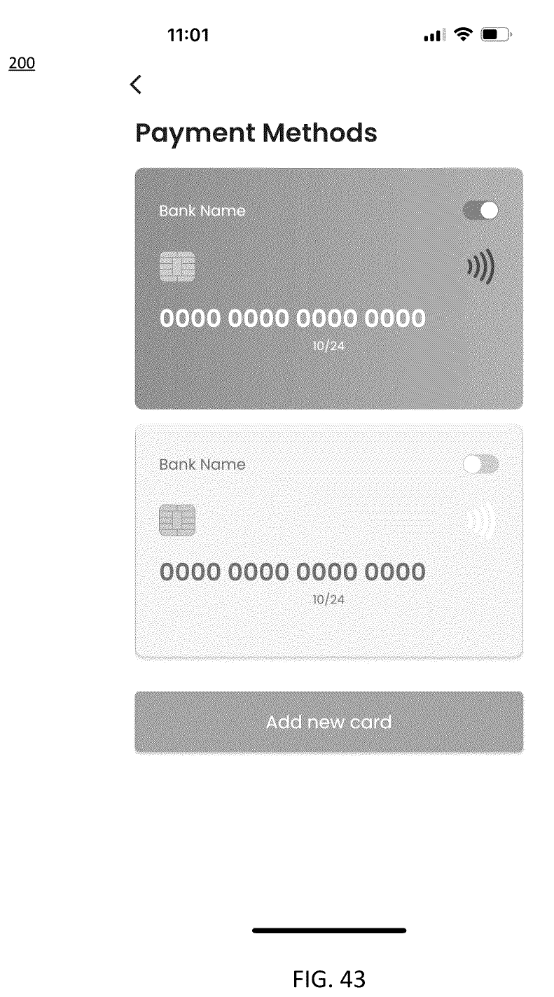

FIGS. 28-39 show example screens of the app 200 in relation to finding service shops 180, scheduling and managing service appointments, receiving service recommendations, and logging past service records as described above. These screens may be accessed using a “Repairs” navigation button as shown. In FIG. 28, upcoming and completed service repairs are shown on the same screen, including the names and locations of the stores, dates of the repairs, parts replaced, and associated costs. FIGS. 29, 30, and 31 show examples in which such information may be separated into different categories for repairs that are in progress, upcoming, and completed, as may be individually viewed using tabs. FIGS. 32, 33, 34, and 35 show details of a service appointment, which may be navigated to by drilling down on one of the appointments listed in FIGS. 28-31 for example. As can be seen, the appointment may have a time slot, services/parts and associated costs that have been selected by the user, and services/parts that have been recommended by the service shop 180. FIGS. 32, 33, and 34 show a newly created, in progress, and completed service appointment, respectively, with FIG. 35 showing a lower portion (scrolled down) of the completed service appointment of FIG. 34. Here, it can be seen that payment may be made within the app 200 using a “Make Payment” button that may link to a website or API for transacting with the service shop 180 (see also FIG. 43 showing an example screen for inputting payment methods). FIG. 36 shows an example screen showing notifications in relation to service appointments. Corresponding notifications may be provided to the user via native notification functionality of the mobile communication device 110 (to appear on a lock screen of the mobile communication device 110, for example).

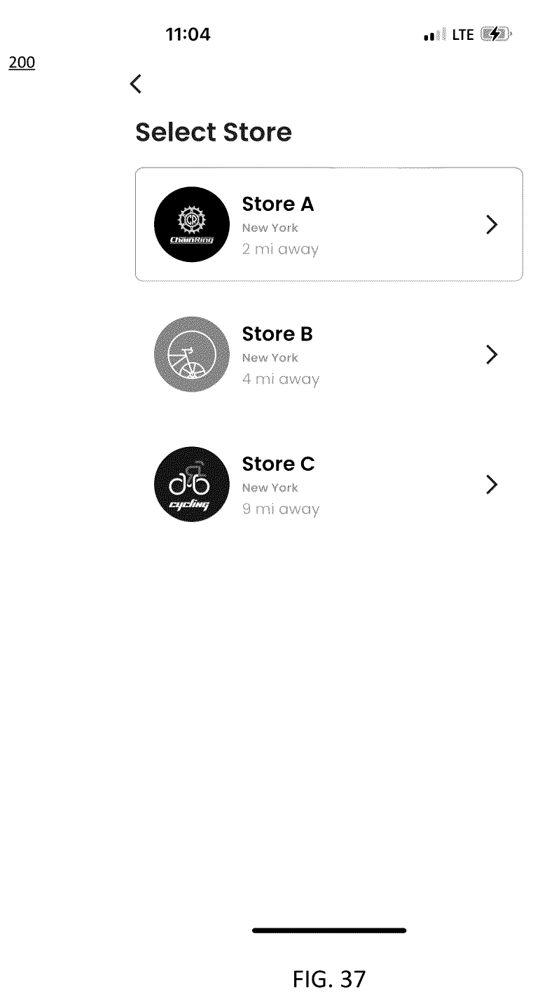

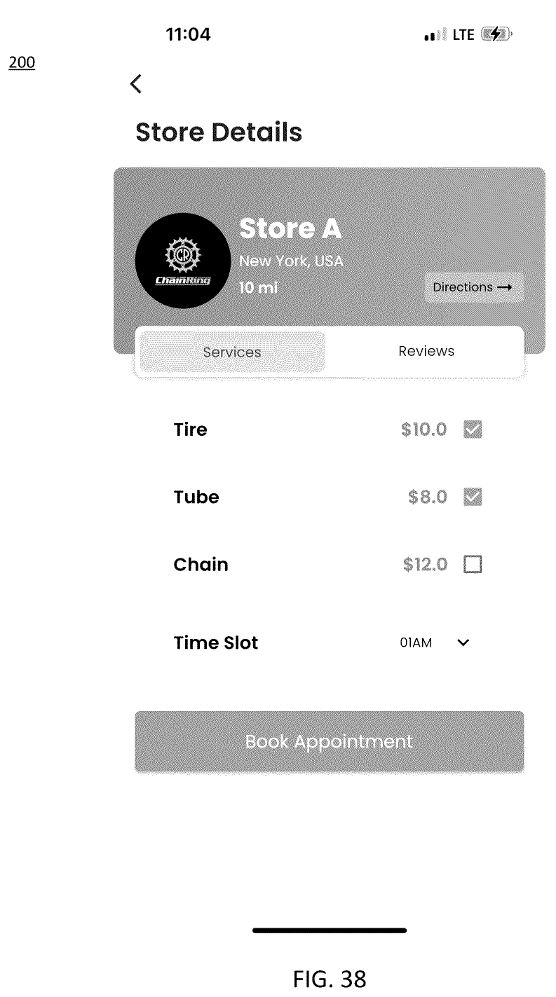

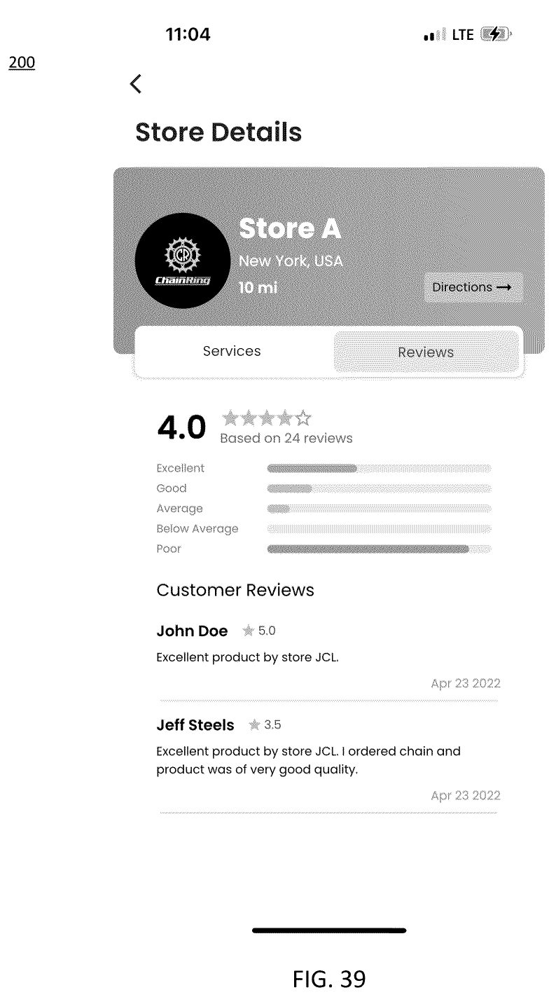

FIGS. 37, 38, and 39 show example screens for selecting a bicycle repair service provider 180. In this regard, as one possible example data flow, the server 120 may receive a request for bicycle repair service from the mobile communication device 110 in response to user input to the mobile application 200 (e.g., tapping “Book Appointment” in the screens of FIGS. 28-31). In response to the request for bicycle repair service, the server 120 may provide, to the mobile communication device 110, one or more geolocations of bicycle repair service providers 180 based on a relationship between the geolocation of each bicycle repair service provider 180 and a geolocation of the mobile communication device 110. To this end, the geolocation of the mobile communication device 110 may be known by the app 200 (e.g., determined using a GPS receiver of the mobile communication device 110 or through communication with a cellular network) and may be provided to the server 120 either in response to the request for bicycle repair service or regularly (e.g., periodically). Based on the relationships between the geolocations, the app 200 may present distance information (e.g., 2 mi away) for each service shop 180 as shown in FIG. 37. The user may tap the store of his/her choice to navigate the app 200 to the screen shown in FIG. 38, where specific services can be selected (and prices displayed), a time slot requested, and an appointment booked with the service shop 180. To aid the user with his selection of stores, the user may navigate to the screen shown in FIG. 39 by switching from the “Services” tab to the “Reviews” tab in FIG. 38. On the screen shown in FIG. 39, various reviews and star ratings of the service shop 180 may be displayed (as may be collected from third-party websites using associated links and APIs, for example). Once the user has made his/her selection, the app 200 may further assist the user with contacting the selected service shop 180 and/or map navigation to the selected service shop 180 (accessed using “Directions” button).

Another aspect of the disclosed system 100 is that it may allow bicycle retailers 170 (see FIG. 1) to report warranty claims directly to the manufacturer 160 together with relevant information about the bicycle 10 in question. To this end, one example data flow may begin with the server 120 receiving a warranty claim from a retail store 170 that includes a bicycle serial number. As explained above, the server 120 may advantageously store bicycle serial numbers in association with user identifiers and may also collect data from sensor(s) 20 and other devices 30 via the app 200 associated with the same user identifier. Upon receiving the warranty claim from the retailer 170, the server 120 may thus associate the warranty claim with the user identified based on the association between the bicycle serial number included in the warranty claim and the user identifier identifying the user of the app 200. As a result, the warranty claim may be associated with all of the data (e.g., history of trip data, past service appointments and repairs, etc.) that is associated with the bicycle 10. The server 120 may then provide such data (e.g., collected trip records) together with the warranty claim to the manufacturer 160 of the bicycle 10. In this way, the manufacturer 160 is able to tap into the core data of the system 100 to understand exactly what is going wrong with the bicycle 10 and create a digital diagnostic in order to appropriately process the warranty claim.

Another aspect of the disclosed system 100 that may be of interest to manufacturers 160 is in relation to safety recalls. An example data flow may begin with the server 120 receiving recall information from a manufacturer 160, where the recall information identifies one or more bicycle model numbers (corresponding to ranges of bicycle serial numbers, for example) that are subject to a recall. By virtue of the fact that the server 120 stores bicycle serial numbers in association with user identifiers of app users, the server 120 may, upon receiving the recall information, associate the recall information with one or more user identifiers of users whose bicycles 10 are under recall. The server 120 may then provide the recall information to the mobile communication device(s) 110 of the users who have bicycles 10 subject to the recall, with the recall information being displayable to the user on the app 200 (preferably via push notification because of its urgency). In this way, manufacturers 160 have a much greater likelihood of reaching the affected audience of recall information as compared to conventional methods such as passively displaying the information on a website or a social media page.

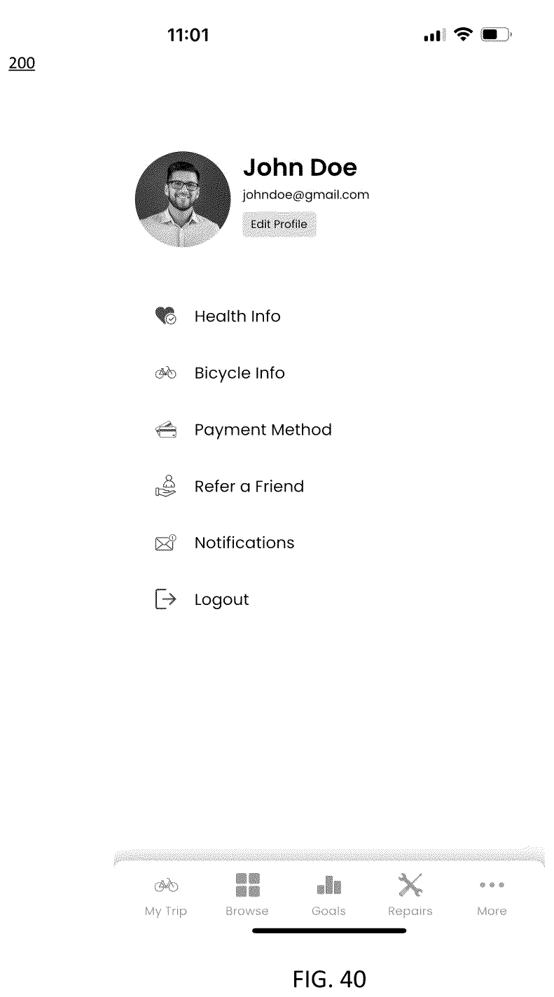

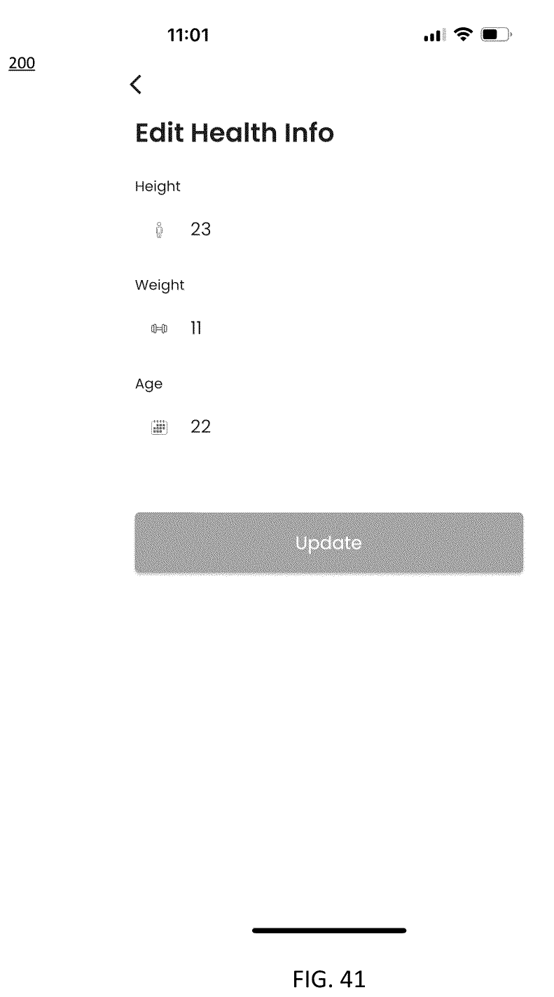

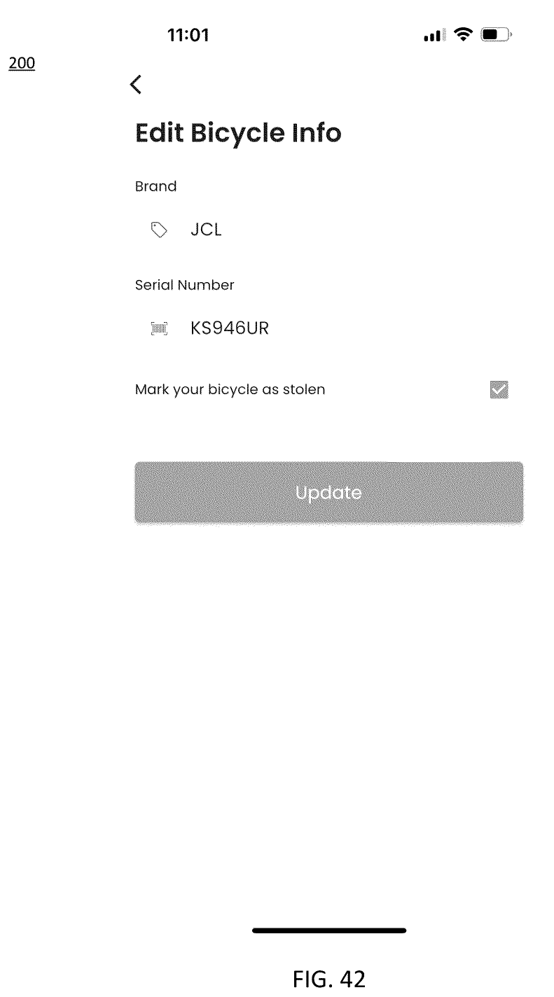

Another aspect of the disclosed system 100, which may be of interest to manufacturers 160, retailers 170, and service shops 180 alike, as well as to the legitimate owners of bicycles 10, is theft detection and prevention. Owing to the serial numbers of all bicycles 10 advantageously being stored by the system 100 (e.g., in the user data storage 130), it can be ensured that if a repair shop 180 or other business comes into contact with a stolen bike they can recognize it and help get it back to its rightful owner. In this regard, one example data flow may begin with the server 120 receiving a theft notification from the mobile communication device 110 in response to a user input to the mobile application 120. For example, the owner of the bicycle 10 may realize that his/her bicycle 10 has been stolen and may submit a request via the app 200 to assist with finding the stolen bicycle 10. Referring to the example screens of the app 200 for editing and updating the user's profile information and payment methods as shown in FIGS. 40-43, there may be a screen as shown in FIG. 42 that includes a checkbox to indicate that the bicycle has been stolen, for example. Alternatively, the theft notification may come from a law enforcement organization rather than the owner of the bicycle 10. In a case where the theft notification comes from the user device 110, the server 120 may associate the theft notification with the bicycle serial number based on the known association between the bicycle serial number and the app user's user identifier. (In the case of law enforcement, the server 120 may be provided with the serial number directly in some cases.) From this point on, the system 100 is aware of the theft and is on the lookout for any activity associated with the bicycle 10. At a later time, the thief may attempt to have the bicycle 10 repaired, sell the bicycle 10, or initiate a fraudulent return of the bicycle 10, for example. The relevant entity 160, 170, 180 who encounters the thief in these situations may issue a request to the server 120 including the bicycle serial number. (The request may be a routine fraud check issued to the server 120 as a matter of course, for example.) Upon recognizing the bicycle serial number as belonging to a stolen bicycle 10, the server 120 may respond to the request by providing the theft notification to the repair shop or other relevant entity 160, 170, 180 (who may then refuse the transaction and contact law enforcement as appropriate).

Another aspect of the disclosed system 100 is the creation of a non-fungible token (NFT) to validate ownership of a bicycle 10 and monitor bicycle sale transactions using blockchain technology. When a bicycle 10 is sold the new owner may correspondingly obtain ownership of the NFT, which may be stored by the server 120 on a blockchain (e.g., a decentralized ledger in a cloud). It is contemplated that all user and bike information (e.g., user identifier, bicycle serial number, etc.) may be stored within the NFT, which may be created upon the original registration of the bicycle 10 with the app 200, for example. In some iterations, the new owner of the bicycle 10 may be able to see previous repairs, warranties, thefts, etc. of the bicycle 10 using the app 200, while manufacturers 160 may be able to know when a bicycle has switched hands, thus potentially voiding the warranty.

In general, owing to the various aspects of the innovative system 100 described herein, data may be shared within the industry to encourage more development based on a more serious monitoring of product performance and customer satisfaction. Manufacturers 160, retail stores 170, and repair service providers 180 will undoubtedly grow with the vast new data available to them about their customers, products, and services. Understanding the typical usage of targeted customers and new insights into customer behaviors can help develop products and services more aligned with changing consumer demands. In this way, as well as in the various ways described above, not only riders but all interested parties will gain from the disclosed systems and methods.

The functionality described above in relation to the components of the system 100 and app 200 shown in FIGS. 1-18 and the operational flows described throughout the disclosure may be wholly or partly embodied in one or more computers including a processor (e.g., a CPU), a system memory (e.g., RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g., over the Internet), such as between the mobile communication device 110 and the server 120 or between the server 120 and computers controlled by manufacturers 160, retailers 170, and service shops 180, etc. To the extent that functionality may be performed at the server 120 rather than by the app 200 on the mobile communication device 110, the server 120 may comprise multiple physical servers and other computers that communicate with each other to perform the described functionality.

The above computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of supporting mobile application-based bicycle repair, the method comprising:
storing a bicycle serial number in association with a user identifier identifying a user of a mobile application;
receiving bicycle trip data from a mobile communication device having the mobile application installed thereon, the bicycle trip data derived by the mobile application based at least in part on sensor data collected from one or more sensors disposed on a bicycle;
associating the bicycle trip data with the bicycle serial number based on the association between the bicycle serial number and the user identifier identifying the user of the mobile application;
providing the bicycle trip data to a bicycle repair service provider capable of deriving bicycle repair service information from the bicycle trip data;
receiving the bicycle repair service information from the bicycle repair service provider; and
providing the bicycle repair service information to the mobile communication device, the bicycle repair service information being displayable on the mobile communication device by the mobile application.

2. The method of claim 1, wherein the bicycle trip data includes one or more items of data selected from the group consisting of speed, duration, distance, cadence, estimated calories burned, incline, decline, battery level, and tire pressure.

3. The method of claim 1, wherein the bicycle trip data is further derived based at least in part on heart rate data collected from a device worn by the user.

4. The method of claim 1, wherein the bicycle trip data is further derived based at least in part on oxygen level data collected from a device worn by the user.

5. The method of claim 1, further comprising storing, in association with the user identifier, a record of bicycle repair service performed on the bicycle.

6. The method of claim 1, further comprising storing a plurality of records of the bicycle trip data in association with the user identifier, wherein an aggregation of the plurality of records is displayable on the mobile communication device by the mobile application.

7. The method of claim 6, further comprising:
receiving, from a retail store, a warranty claim including the bicycle serial number;
associating the warranty claim with the user identifier based on the association between the bicycle serial number and the user identifier identifying the user of the mobile application; and
providing the plurality of trip records and the warranty claim to a manufacturer of the bicycle.

8. The method of claim 1, further comprising:
receiving, from a manufacturer of the bicycle, recall information including one or more bicycle model numbers corresponding to the bicycle serial number;
associating the recall information with the user identifier based on the association between the bicycle serial number and the user identifier identifying the user of the mobile application; and
providing the recall information to the mobile communication device, the recall information being displayable on the mobile communication device by the mobile application.

9. The method of claim 1, further comprising:
receiving a theft notification from the mobile communication device in response to a user input to the mobile application, the theft notification indicating that the bicycle has been stolen;
associating the theft notification with the bicycle serial number based on the association between the bicycle serial number and the user identifier identifying the user of the mobile application;
receiving, from the bicycle repair service provider, a request including the bicycle serial number; and,
in response to the request, providing the theft notification associated with the bicycle serial number to the bicycle repair service provider.

10. The method of claim 1, further comprising:
receiving a request for bicycle repair service from the mobile communication device in response to a user input to the mobile application;
receiving, from the mobile communication device, a geolocation of the mobile communication device; and,
in response to the request for bicycle repair service, providing, to the mobile communication device, one or more geolocations of bicycle repair service providers based on a relationship between the one or more geolocations and the geolocation of the mobile communication device.

11. A method of supporting mobile application-based bicycle warranty claim processing, the method comprising:
storing a bicycle serial number in association with a user identifier identifying a user of a mobile application;
receiving bicycle trip data from a mobile communication device having the mobile application installed thereon, the bicycle trip data derived by the mobile application based at least in part on sensor data collected from one or more sensors disposed on a bicycle;
associating the bicycle trip data with the bicycle serial number based on the association between the bicycle serial number and the user identifier identifying the user of the mobile application;
receiving, from a retail store, a warranty claim including the bicycle serial number;
associating the warranty claim with the user identifier based on the association between the bicycle serial number and the user identifier identifying the user of the mobile application; and
providing the bicycle trip data and the warranty claim to a manufacturer of the bicycle.

12. A method of supporting mobile application-based bicycle trip analysis, the method comprising:
storing a bicycle serial number in association with a user identifier identifying a user of a mobile application;
receiving bicycle trip data from a mobile communication device having the mobile application installed thereon, the bicycle trip data derived by the mobile application based at least in part on sensor data collected from one or more sensors disposed on a bicycle;
associating the bicycle trip data with the bicycle serial number based on the association between the bicycle serial number and the user identifier identifying the user of the mobile application;
storing a plurality of records of the bicycle trip data in association with the user identifier;
receiving a request for trip analysis from the mobile communication device in response to a user input to the mobile application; and
providing an aggregation of the plurality of records to the mobile communication device, wherein the aggregation of the plurality of records is displayable on the mobile communication device by the mobile application.
